(19) United States
(12) Patent Application Publication
(10) Pub. No.: US 2003/0109284 A1
(43) Pub. Date: Jun. 12, 2003

(54) Flexible carrier utilization

(76) Inventors: Dag Akerberg, Kungsangen (SE); Kimmo Hiltunen, Esbo (FI)

Correspondence Address: NIXON & VANDERHYE P.C., 8th Floor, 1100 North Glebe Road, Arlington, VA, 22201, US

(21) Appl. No.: 10/233,663

(22) Filed: Sep. 4, 2002

Related U.S. Application Data
(60) Provisional application No. 60/336,715, filed on Dec. 7, 2001.

(51) Int. Cl. H04Q 7/20; H04M 1/00; H04B 1/38

(52) U.S. Cl. 455/561; 455/437; 455/552

(57) ABSTRACT

In the present invention, carrier pairs of one uplink carrier (UL1, UL2) and one downlink carrier (DL1, DL2) are provided with a flexible duplex frequency separation distance in a cellular communication system (1) operating according to a FDD concept. At least a first carrier pair used in the system has a different duplex frequency separation distance than a second carrier pair. The duplex frequency separation distance may vary within one cell (12H, J) and/or between different cells (12H, J) in the same system (1), preferably dependent on the traffic situation and preferably on a per connection or per code basis. The increased flexibility in pairing different available uplink and downlink carriers makes it possible to match different kinds of asymmetries in the system (1) in order to increase the overall transmission capacity

### TECHNICAL FIELD

The present invention relates generally to cellular communication systems and in particular to radio carrier utilization in such cellular communication systems.

### BACKGROUND

Most cellular communication systems of today were originally developed to handle typical phone connections, involving a relatively well determined, symmetric, but rather limited bandwidth. However, a general trend in cellular communication systems of today is to provide higher data rates, requiring broad band communication. The future traffic is also assumed to be more asymmetric concerning requested data rates in uplink and downlink connections, respectively. New broad band cellular standards, such as UMTS (Universal Mobile Telecommunication System), provide high data rate services. However, the requirements for high data rate imply a broad modulation spectrum and thereby relatively large frequency separation between the RF (radio frequency) carriers. The nominal RF carrier separation for UMTS is e.g. 5 MHz. Since each operator is allowed to operate only in a limited licensed frequency spectrum, the large frequency separation between the RF carriers implies that each operator has a relatively low number of available carriers to use.

For example, in UMTS FDD (Frequency Division Duplex), also called WCDMA (Wideband Code Division Multiple Access), operators are licensed to get typically 2×10 MHz and in some cases 2×15 MHz frequency spectrum intervals each. An operator thus has one block of typically 2 (or 3) adjacent up-link/down-link, UL/DL pairs of licensed carriers available for the traffic. The uplink and downlink pairs are hard coupled, i.e. there is a fixed frequency separation between the two frequencies. Hence, e.g. the WCDMA downlink band of 2110-2170 MHz is directly connected to an uplink band separated 190 MHz. 190 MHz is called the duplex distance. In other systems, the duplex distance may differ, but is always constant within the communication system in question.

An operator needs to carry as much traffic as possible on his spectrum without degrading service quality. He needs, for instance, to provide coverage over large areas with modest traffic as well as to locally, at so called “hot spots”, provide very high traffic capacity. A typical place, where such “hot spots” may appear is in official buildings, office buildings, railway stations, airports etc. The “hot spot” problem is traditionally solved by having an overlay/underlay cell structure. A number of small pico or micro cells are provided within the coverage area of a larger macro cell. Typically, the micro cells correspond to indoor areas, whereas the macro cells cover outdoor areas. By providing handover between the two structures, the small cell structure will only be needed locally when the very high traffic is needed, or where the coverage from the macro cell is marginal, which may be the case in some indoor sites. The small cell structure can, however, also be an outdoor structure or a combination of indoor and outdoor structures. Principally, more than two different sized cell structures could be superimposed.

Traditionally, for narrow band cellular standards, operators employing overlay/underlay cell infrastructures use different radio communication carriers for the different cell layers in order to reduce mutual interference between the cell layers. This is a natural technique for narrow band operators as a relatively large number of carriers are available to each operator. Even if a number of carriers are used in a micro cell structure, there are several available carriers for the macro cell to use.

However, applying the same structures on broadband systems leads to problems, since the number of carrier pairs is substantially reduced. In a WCDMA system, an operator has typically only two or three carrier pairs available. An operator having a limited number of carrier pairs faces the problem of assigning carriers to the macro/micro cell structures in an efficient manner. In prior art, an operator employees one of the two following concepts, (A) the operator assigns different uplink/downlink carrier pairs to the micro and macro cell, respectively or (B) the operator allow the micro cell to use some or all of the uplink/downlink carrier pairs assigned also to the macro cell.

If concept A is applied, the available carrier pairs are divided between the cell layers, which may result in an inefficient use of the available spectrum. For example, if an operator only has access to 2 carrier pairs, the capacity of the macro cell has to be decreased by 50 percent in order to allow the micro cell structure to operate at all. In most systems, this is unacceptable. Operators of these systems have instead to apply concept B, where the same carrier pairs are reused in both layers in the infrastructure. This is feasible as long as the traffic in the underlay cell is low.

However, the underlay cell traffic can interfere with the macro cell traffic and can, with increasing cell traffic, gradually reduce the capacity of the macro cell beyond an acceptable level. Then, from a capacity point of view, the operator nevertheless ends up with a situation similar to concept A, i.e. the carrier pair being used by the underlay cell will more or less be useless for the macro cell. As a summary, according to prior art concepts, an operator having only a few carrier pairs available and wants to apply an overlay/underlay cell structure has to choose between substantial overlay (macro) cell capacity reduction, or difficult interference situations as the underlay (micro) cell traffic increases.

In a general cellular communication system, communication takes place from a mobile unit to a base station, so called uplink traffic, as well as from the base station to the mobile unit, so called downlink traffic. In order to avoid interference between uplink and downlink traffic, they are typically separated in time or frequency. Thus, in systems where the frequency is used to separate uplink and downlink traffic, one frequency is only used for uplink traffic and another frequency is used only for downlink traffic. The frequency distance between the uplink and downlink frequencies is called the duplex distance. Traditional voice communication gives a relatively symmetric load of uplink and downlink traffic. Therefore, a general manner in which frequency bands are assigned is in uplink/downlink pairs, having a fixed duplex distance within each system.

However, a general trend when going to more general types of communication is that the traffic becomes more or less asymmetric. In many cases, the downlink traffic is believed to require larger capacity than the corresponding uplink traffic. In asymmetric cellular systems, the uplink and downlink may differ in terms of modulation, slot format, interleaving and coding. However, the use of pairs of uplink and downlink resources may lead to frequency spectrum utilization problems. If the downlink traffic is more intense, the downlink resource will reach its maximum capacity while there still are remaining capacity in the uplink resource. Such unused uplink capacity is not possible to use by prior art systems. Likewise, if the uplink traffic would be larger than the downlink, the uplink resource will be fully occupied while leaving unused downlink capacity blocked. The two situations may even be present in different cells of one and the same cellular system.

### SUMMARY

A general problem of prior art frequency duplex division (FDD) cellular communication systems can be summarized in that there is an inefficient utilization of the available frequency spectrum at layered structures and/or at asymmetric traffic situations.

A general object of the present invention is thus to provide methods, systems and devices giving a more efficient utilization of an available frequency spectrum. A further object of the present invention is to provide methods, systems and devices allowing a more flexible assignment of uplink and downlink carriers. Yet a further object of the present invention is to provide methods, systems and devices utilizing unpaired frequency spectrum for frequency duplex division applications.

The above objects are achieved by methods, systems and devices according to the enclosed patent claims. In general words, carrier pairs of one uplink carrier and one downlink carrier are provided with a flexible duplex frequency separation distance. At least a first carrier pair used in a cellular communication system operating at least partially according to frequency division duplex has a different duplex frequency separation distance than a second carrier pair. The duplex frequency separation distance may vary within one cell and/or between different cells, preferably dependent on the traffic situation and preferably on a per connection or per code basis (for CDMA systems). The increased flexibility in pairing different available uplink and downlink carriers makes it possible to- match different kinds of asymmetries in the system in order to increase the overall transmission capacity. In this manner, also unpaired spectra can be utilized in FDD systems.

### BRIEF DESCRIPTION OF THE DRAWINGS

The invention, together with further objects and advantages thereof, may best be understood by making reference to the following description taken together with the accompanying drawings, in which:

FIG. 1 is an illustration of a cellular communication system;

FIG. 2a is an illustration of carrier assignments of a cellular communication system according to prior art;

FIG. 2b-c are illustrations of transmission capacities in two of the cells of FIG. 2a;

FIG. 3a is an illustration of carrier assignments of a cellular communication system according to the present invention;

FIG. 3b-e are illustrations of transmission capacities in four of the cells of FIG. 3a;

FIG. 4a is an illustration of carrier assignments of two cells in a cellular communication system according to prior art;

FIG. 4b-c are illustrations of transmission capacities in the cells of FIG. 4a;

FIG. 5a is an illustration of carrier assignments of two cells in a cellular communication system according to the present invention;

FIG. 5b-c are illustrations of transmission capacities in the cells of FIG. 5a;

FIG. 6 is an illustration of an indoor/outdoor layered cellular communication system;

FIG. 7 is an illustration of possible incorporation of different radio technologies in a system according to FIG. 6;

FIG. 8a is an illustration of transmission capacities in the system of FIG. 6 using prior art techniques;

FIG. 8b-e are illustrations of transmission capacities in the system of FIG. 6 using techniques according to the present invention;

FIG. 9 is a schematic drawing of a cellular communication system node according to an embodiment of the present invention;

FIG. 10 is a schematic drawing of a mobile station according to an embodiment of the present invention; and

FIG. 11 is a flow diagram illustrating basic steps of an embodiment of a method according to the present invention.

### DETAILED DESCRIPTION

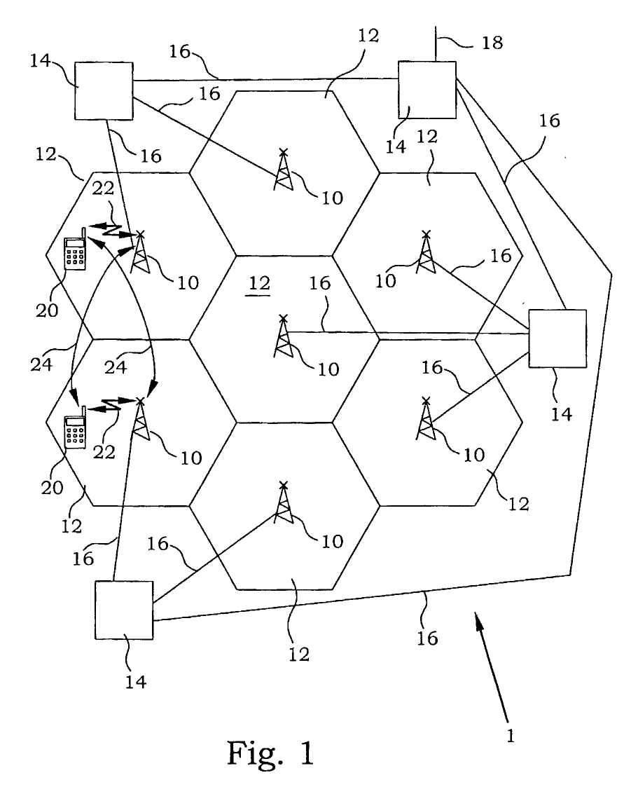

A general cellular communication system 1 is illustrated in FIG. 1. The cellular communication system 1 is a system based at least partially on frequency duplex division (FDD) technique, i.e. using different frequencies to separate uplink and downlink traffic. In most embodiments described below, a WCDMA system is assumed, but the present invention is also applicable to other cellular communication systems employing frequency separation of uplink and downlink traffic.

A number of base stations 10 associated with a certain coverage area or cell 12 cover together a large geographical area. The base stations 10 are connected to nodes 14 of a core radio network by means of stationary connections 16. The core radio network is in turn connected to other external communication systems by interconnections 18. Mobile stations 20 being present within the total coverage area of the cellular communication system 1. The mobile stations 20 are in radio contact 22 with one of the base stations 10. The radio communication between a mobile station 20 and the base station 10 associated with the cell 12 in which the mobile station 20 is present may also interfere 24 with mobile stations 20 or base stations 10 in adjacent cells 12.

In the present disclosure, the word “carrier” is used denote a certain RF frequency on which communication takes place. “Downlink” communication denotes communication from a base station to a mobile station. Consequently, “uplink” communication denotes communication from a mobile station to a base station. A “carrier pair” denotes a pair of one carrier used for uplink communication and one carrier used for downlink communication.

In an FDD system, any two-way communication between a base station and a mobile station takes place using different carriers. During the procedure of locking the mobile station to a certain base station or during e.g. handover between different cells, different carriers can be employed, depending on the actual standard used by the system. The way to use the carriers during such procedures may also be performed according to the present invention. However, the main target for the present invention is how to handle the selection of carriers for active modes of communication between a mobile station and a base station. When a call or session is to be started, the communication between the base station and the mobile station is assigned a carrier pair. The selection and assignment is typically performed by the base station or any other node in the core radio network. In systems according to prior art, a frequency and/or other identification of the uplink or downlink carrier is given to the mobile station by the base station. Prior art systems have a fixed duplex distance, therefore once one carrier is known the mobile station also knows the frequency of the other carrier to be used. Such assignment of carriers is typically performed by the core network based on the geographical relations, i.e. cell sizes and shapes, signaling strengths, interference situations etc. to assure a certain quality of service.

In systems according to the present invention, the duplex distance of a carrier pair may vary within the system and even within one single cell. This means that an uplink carrier can be associated to a downlink carrier in a more flexible manner. When instructing a mobile station about which carriers to use for a certain session or call, not only one of the carrier frequencies has to be reported, but also the other carrier frequency or the actual duplex distance used in this case. The benefit of such a flexible carrier pair assignment will be illustrated by a few illustrative examples below.

First, a few examples related to general types of cellular communication systems will be discussed. Thereafter, the beneficial application of the present invention on overlay/underlay systems will be exemplified.

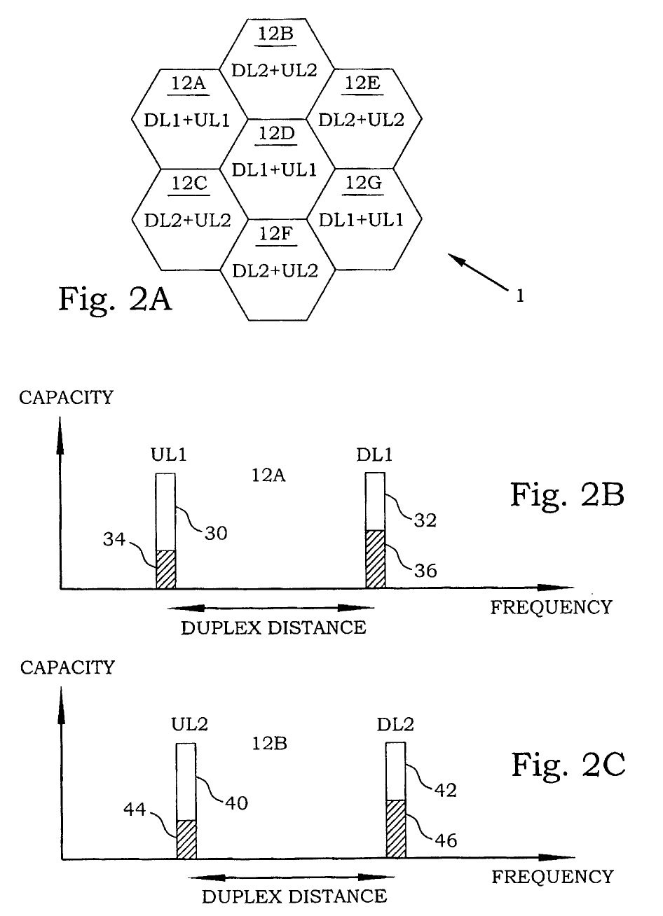

In FIG. 2A, a part of a general type of cellular communication system 1 is schematically illustrated. Seven cells 12A-G are indicated by the border of the associated cell. An operator of this system is licensed to two frequency bands of 10 MHz each, which makes it possible to use two carrier pairs of 2×5 MHz bandwidth each. In order to reduce any interference between adjacent cells, the operator allows the different cells to use only one of the carrier pairs each. Cells 12A, 12D and 12G have access to a first pair of uplink and downlink carriers, UL1 and DL1, respectively, while the remaining cells use a second carrier pair, UL2 and DL2. The system has a carrier reuse of 2.

The frequency band situation in cell 12A is illustrated in FIG. 2B. DL1 and UL1 are available for communication, illustrated by the rectangles 30, 32 in the diagram. Cell 12D uses the same carrier pair and since the cells are situated so close to each other, there is a significant risk for interference if both cells are using the same resources of the carrier at the same time. In order to avoid interference, cell 12A and cell 12D divides the available carrier resources between them, in the present example 50% each. Such a division of resources can e.g. be performed using coding or time slot techniques. In FIG. 2B, a situation where the maximum capacity available for cell 12A is used is illustrated, assuming that the amount of downlink traffic is double the uplink traffic. Since half the resources of the available downlink carrier DL1 32 can be used, the system allows downlink traffic corresponding to half the total capacity of downlink carrier DL1 32, illustrated by the hashed rectangle 36. The corresponding uplink traffic will in such a case occupy 1/4 of the capacity of the uplink carrier UL1 30, illustrated by the hashed rectangle 34. As easily noticed, there are a lot of unused communication capacity.

In FIG. 2C, a corresponding diagram showing the, situation in cell 12B is illustrated. A downlink carrier DL2 42 is used up to 50% as indicated by the hashed rectangle 46 and an uplink carrier UL2 40 is used by 1/4 as indicated by the hashed rectangle 44. Also here, the capacity utilization is relatively low. If the traffic is increased further, the risk for interference is large and the quality of service can not be guaranteed.

FIGS. 2A-C are illustrations of a system operated according to prior art.

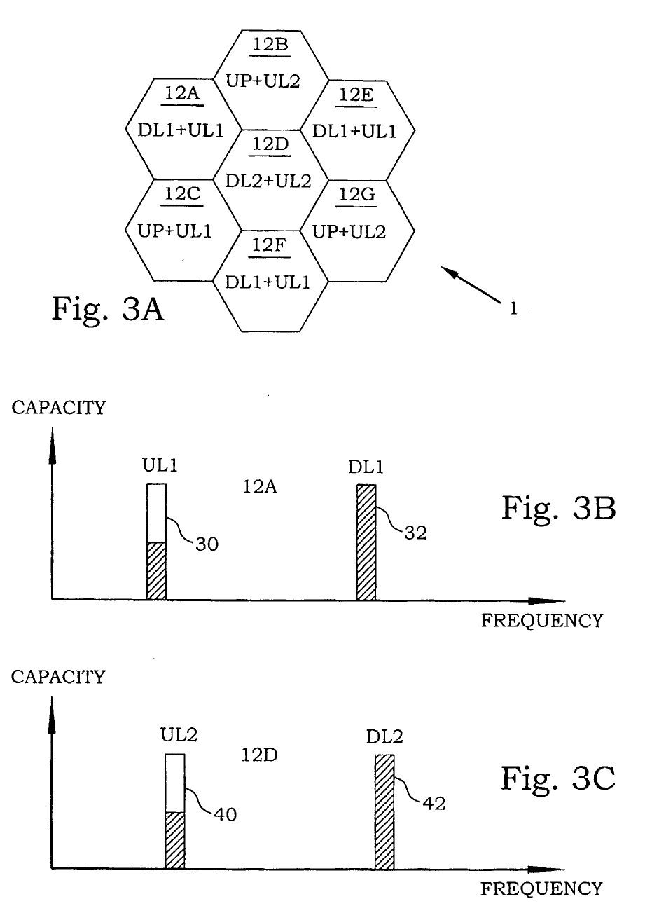

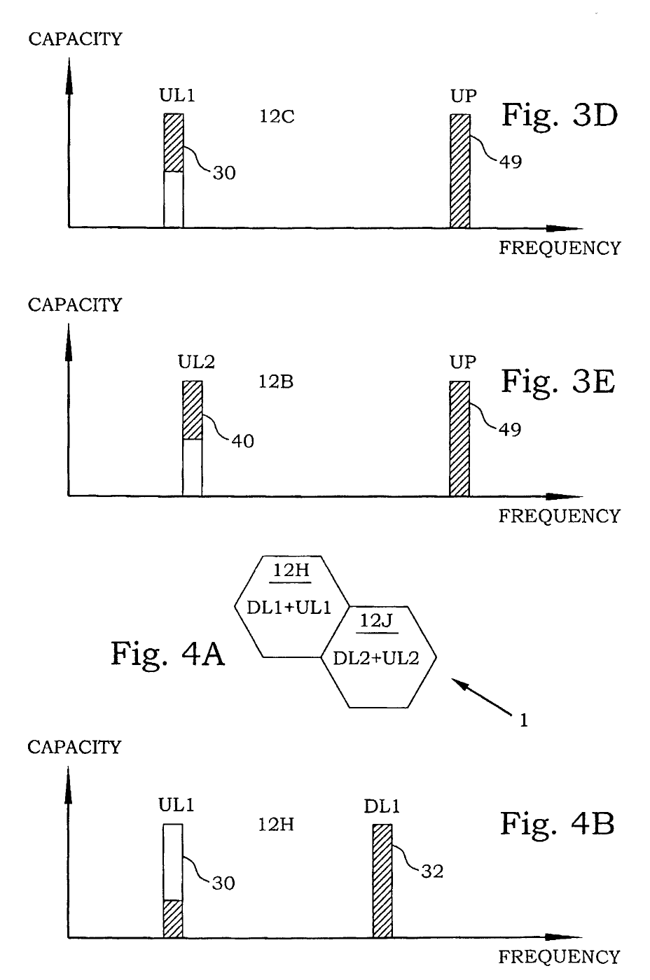

In FIG. 3A, the same system is operated according to the present invention. The uplink carriers UL1 and UL2 are available, as well as the downlink carriers DL1 and DL2. However, an additional unpaired frequency carrier UP is available. In the prior art system, such an extra carrier resource would not change the situation at all, since there is no corresponding uplink carrier at the fixed duplex distance. However, in a system according to the present invention, such extra resources may give large improvements. The cells 12A-G are also here given a certain carrier pair to use, however, the duplex distances may vary. Cell 12A is assigned the pair of DL1 and UL1, cell 12B is assigned the pair of the additional unpaired UP carrier and UL2, cell 12C is assigned the carrier pair of the additional unpaired UP carrier and UL1 etc., according to the indications in the figure.

In FIGS. 3B-E, are the situations in cells 12A, 12D, 12C and 12B, respectively, illustrated. In cell 12A, UL1 30 and DL1 32 are available. DL1 32 is here fully used, while UL1 30 is used to 50%. In cell 12D, UL2 40 and DL2 are available. DL2 42 is here fully used, while UL2 40 is used to 50%. There is no risk for interference between these two cells. In cell 12C, UP 49 is available as the downlink carrier and UL1 30 as an uplink carrier. UP 49 does not interfere with any of the downlink carriers of cells 12A or 12D. UL1 30 is also used by cell 12A, and the available resources have to be divided between the two cells. Since the downlink traffic is so much larger, UL1 30 has enough capacity to handle the uplink traffic corresponding to both downlink carriers DL1 32 and UP 49. Similarly, cell 12B uses UP 49 as the downlink carrier and UL2 40 as the uplink carrier. Also here, UL2 40 is shared between two adjacent cells.

By this example, it is seen that by introducing the flexible duplex distance according to the present invention, an additional carrier corresponding to 25% of the original capacity and which was of no use for a prior art system will increase the useful capacity of the system by 100%. The asymmetry of the traffic is by use of the ideas of the invention matched to an asymmetry in the available uplink/downlink carriers. This matching can in certain situations increase the efficiency of the spectrum use tremendously. In this present example, the duplex distance is constant within each individual cell, but varies from one cell to another within the system.

When new spectrum is allocated for operators to use, there may be different amounts available for the up- and downlinks, and some un-paired carriers may be left close to the uplink block or the downlink block. Such un-paired carriers are licensed, primarily with the intention to be used by TDD techniques, since un-paired spectra in prior art have been impossible to utilize for FDD technologies. The notation un-paired spectrum has appeared because prior art FDD technologies use the same bandwidth and the same carrier spacing for up- and downlinks and also pair them in a fixed association with a fixed duplex separation frequency distance. As seen in the above example, by using the present invention, un-paired spectrum can easily be utilized in FDD systems.

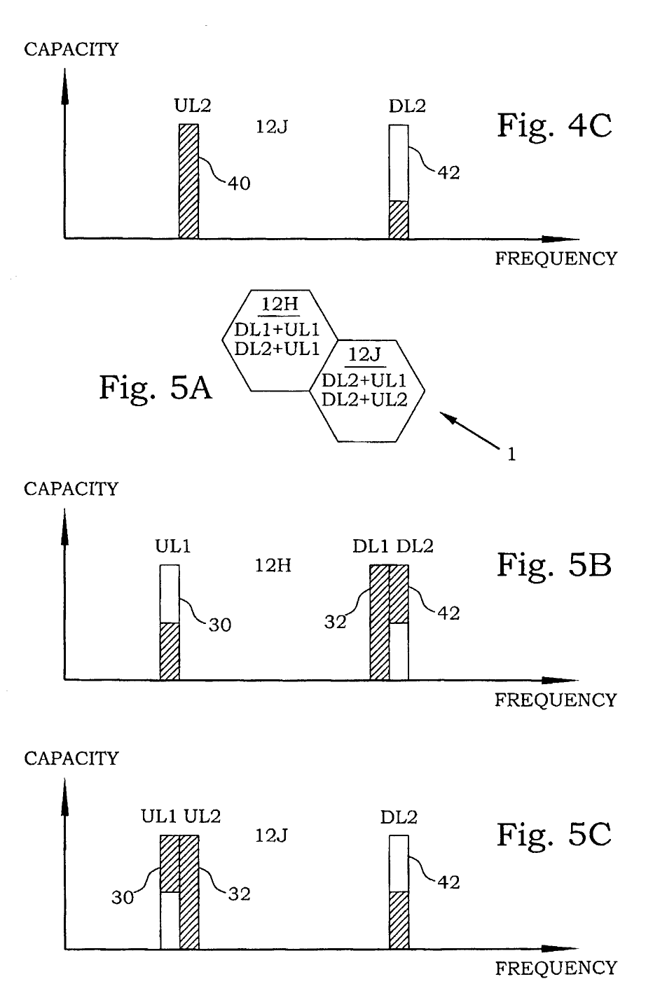

Another system, not specifically employing overlay/underlay techniques, in illustrates in FIG. 4A, where two cells 12H and 12J of a cellular communication system 1 are shown. The operator of the system has access to two conventional uplink/downlink pairs, UL1/DL1 and UL2/DL2. Cell 12H is given one pair to use, and cell 12J is given the other pair to use. Now assume that in cell 12H, the downlink traffic is three times larger than the uplink traffic. The situation in cell 12J is the opposite, i.e. the uplink traffic is three times larger than the downlink traffic. According to prior art, the ultimate traffic situation would look like FIGS. 4B and 4C. In FIG. 4B, in cell 12H, DL1 32 is filled with traffic, while UL1 30 is used only to ⅓. In FIG. 4C, in cell 12J, UL2 40 is totally filled with traffic, while DL2 42 is used only to ⅓. Significant parts of the frequency spectrum are unused.

FIG. 5A illustrates the same two cells 12H and 12J in a communication system applying the principles of the present invention. The operator of the system has still only access to the two uplink/downlink pairs, but will now have the flexibility to assign any of the uplink carriers with any of the downlink carriers. In FIG. 5A it is assumed that cell 12H is allowed to use UL1 30 in combination with either DL1 32 or DL2 42. It is further assumed that cell 12J is allowed to use DL2 42 in combination with either UL1 30 or UL2 40. According to the present invention, as illustrated by FIG. 5B, cell 12H uses the entire DL1 carrier 32 and half the DL2 carrier 42 for its purposes. The corresponding uplink traffic is handled by UL1 30. This means that 1/3 of the downlink traffic has a different duplex distance as compared with the rest of the downlink traffic, within the same cell. Correspondingly, as illustrated by FIG. 5C, cell 12J uses the entire UL2 carrier 40 and half the UL1 carrier 30 for its purposes. The corresponding downlink traffic is handled by DL2 42. Also here, the duplex distance varies within one and the same cell.

The example in FIGS. 5A-C illustrates that in a certain traffic situation, the maximum traffic capacity can be increased by 50%, with unchanged carrier availability, just by implementing the ideas of the present invention. Here, an asymmetry of the traffic within each cell is matched with another asymmetry of the traffic between the cells to gain capacity.

Anyone skilled in the art understands that for perfectly symmetric systems with perfectly symmetric conditions, there will be no gain by applying the present invention. However, since such ideal system do not exist in reality, some benefits are expected to appear in all practical systems. It is also obvious that the actual present traffic situation often is very important for how to best implement the invention. How large capacity increase that can be achieved thus heavily depends on the actual traffic situation. The two examples described further above are taken at rather favorable conditions, but the capacity enhancement is surprisingly large also at other situations.

In a preferred embodiment of the present invention, the selection of uplink/downlink pairs to be used is continuously adapted according to the present and/or expected near future traffic situation. In systems, where the duplex distance is allowed to vary within each individual cell, the adaptation can even be performed on a per connection or code basis. In a system where the duplex distance is allowed to vary only between the different cells, the flexibility to adapt the assignment according to the traffic situation is somewhat restricted, and is believed to be pre-planned configurations based on statistically determined traffic situations.

Many different asymmetries in the system can be used in order to achieve a beneficial carrier assignment. In layered cell structures of micro and macro cells, expected asymmetries in interference probability can be used to achieve large enhancements in efficiency.

An embodiment of the present invention applied to an indoor/outdoor scenario will be described below. The indoor underlay infrastructure is present within the coverage area of the macro cell. To describe this scenario, it is important to first analyze a typical cellular indoor scenario. Handover between the indoor and outdoor infrastructures is a basic requirement. Thus, the two layered infrastructures are parts of a single cellular network for public access.

Indoor cellular radio coverage by means of an indoor infrastructure is today totally dominated by distributed antenna systems (DAS). DASs are also foreseen to continue to be the dominant cellular indoor infrastructure solution at least for the next 5 or 10 years. DAS is, furthermore, very suitable for e.g. UMTS, WCDMA. For further discussions about DAS, see e.g. “Practical Strategies for Designing, Planning and Implementing In-Building Solutions”, Stephan Merric, REMEC, Post Conference Workshop, IIR's European Summit 202, In-Building Coverage, Apr. 22-25, 2002, Barcelona.

The DAS off-loads the macro cells and provides a controlled indoor radio environment as regards quality and capacity. Distributed indoor antenna systems connected to a core network via a macro/micro radio base station, RBS, is a very attractive way to give indoor coverage. Several operators and technologies can be connected to a common distributed indoor antenna system. This is a main requirement for all public indoor sites like airports, shopping centers etc., but also for private office complexes rented to different companies. The indoor services will also automatically follow the macro core network service developments. A distributed antenna system today connected to GSM RBSs can tomorrow additionally be supporting UMTS FDD services by connecting a WCDMA RBS.

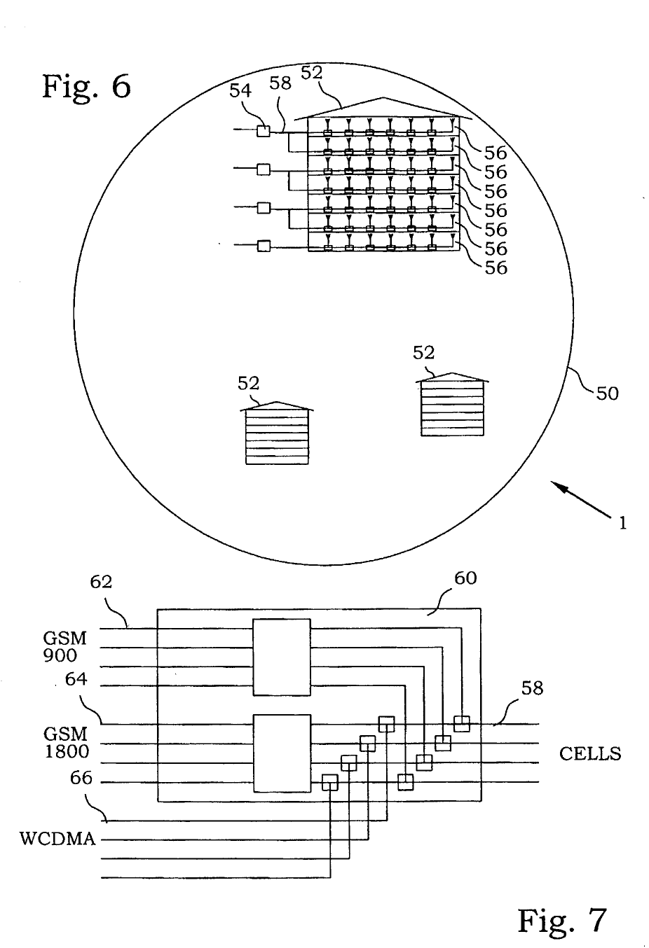

FIG. 6 illustrates an indoor/outdoor cellular communication system 1. A macro cell 50 covers an area enclosing three buildings 52. Every floor in the buildings constitutes one micro cell 56, having its own DAS 58 (of which only one is marked in the figure to increase the readability). Each DAS 58 with its antenna heads and feeders are supplied by a separate micro/macro RBS 54.

For a specific operator, the whole building may instead consist of one single micro cell. This implies that all antenna heads and feeders in the entire building are connected to one and the same micro/macro RBS owned by the operator. However, to increase capacity, the antenna heads and its feeders can be arranged so that for example every second or as described above every floor is a separate micro cell supplied by a separate micro/macro RBS.

In FIG. 7, the flexibility concerning different technologies is illustrated. Here, a combining box 60 acts as a combiner/splitter between different technologies and the micro cells. Here, connections to e.g. a GSM 900 system 62, a GSM 1800 system 64 and a WCDMA system 66 are selectively connected to the DAS 58 in the cells.

Returning to FIG. 6, simulation and analysis show that for WCDMA DAS, the same UL/DL carrier pair can be reused in each cell (floor) without hardly any capacity reduction due to interference. This is due to the natural isolation between floors. Thus each floor could provide the capacity of an isolated WCDMA cell. Handover must of course be provided between the indoor cells.

The capacity of an UL/DL carrier pair in a macro cell will typically be about half of the capacity of an isolated cell. This is because the interfering load from the adjacent cells reusing the same carriers. Macro cells have much less mutual isolation than indoor cells on different floors.

Thus, we see that by using a single WCDMA UL/DL carrier pair for (several) indoor installations within the coverage of a macro cell, the offered capacity will be manifold larger than using the same UL/DL carrier pair in the macro cell.

A problem is that it is expensive to install indoor infrastructures. This is economic mainly for large public indoor sites like airports, shopping centers etc., and the vast majority of indoor locations have to rely on coverage from outdoor cells. Therefore, an operator only having two or three DL/UL carrier pairs cannot afford to reduce his macro cell capacity by 1/2 or 1/3 by setting aside one carrier pair solely for the indoor sites, according to one of the prior art approaches (A).

According to the other of the prior art approaches (B), the DL/UL carrier pairs used by the indoor system are also used for the macro cell layer. This case has been thoroughly analyzed. The results of the detailed investigation is that the indoor cells, due to the small distances between antenna heads and users can easily be designed not to suffer from macro cells using the same carriers. It is also observed that the capacity reduction from the indoor cells to the macro cells is not on the downlink, but on the uplink. This uplink reduction comes mainly from top floors in line-of-sight with the macro site. This means that only uplink communication of a carrier of the micro cells interferes with macro cell traffic on the same carrier. Downlink communication in a micro cell will hardly interfere at all with downlink communication on the same carrier in the macro cell. This asymmetry between downlink and uplink interference is used according to the concepts of the present invention.

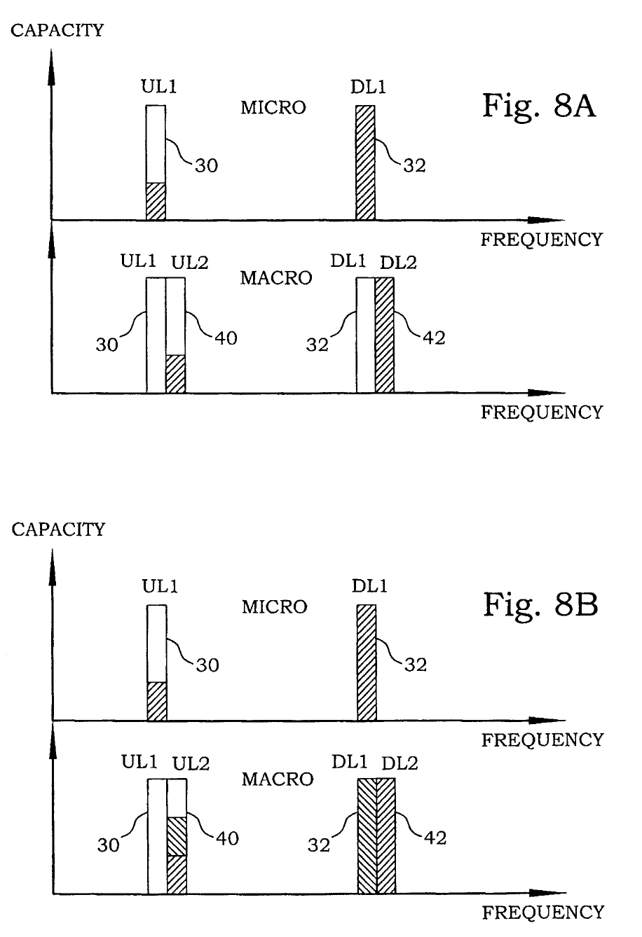

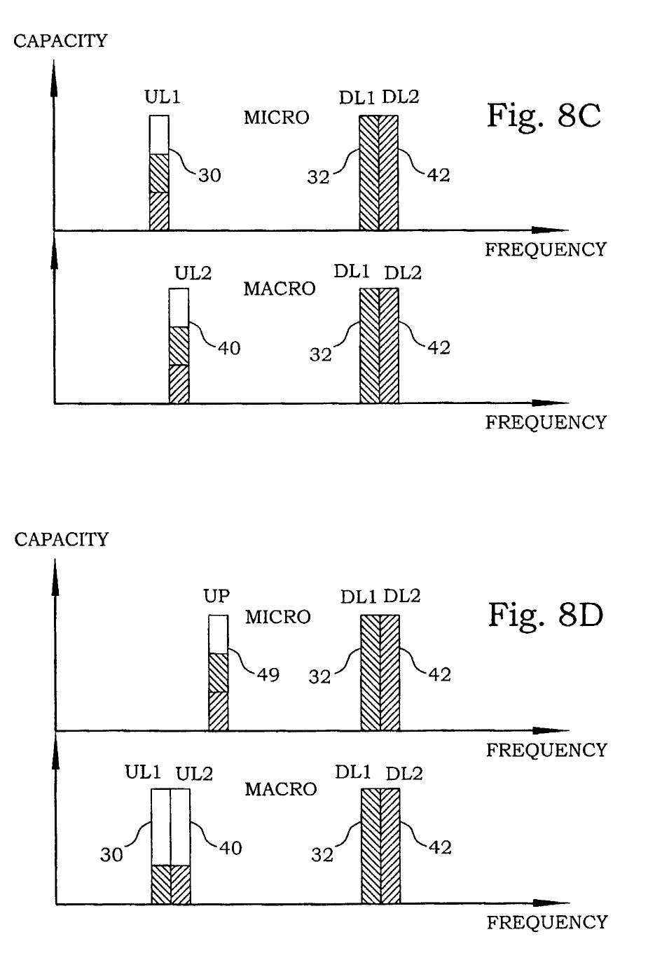

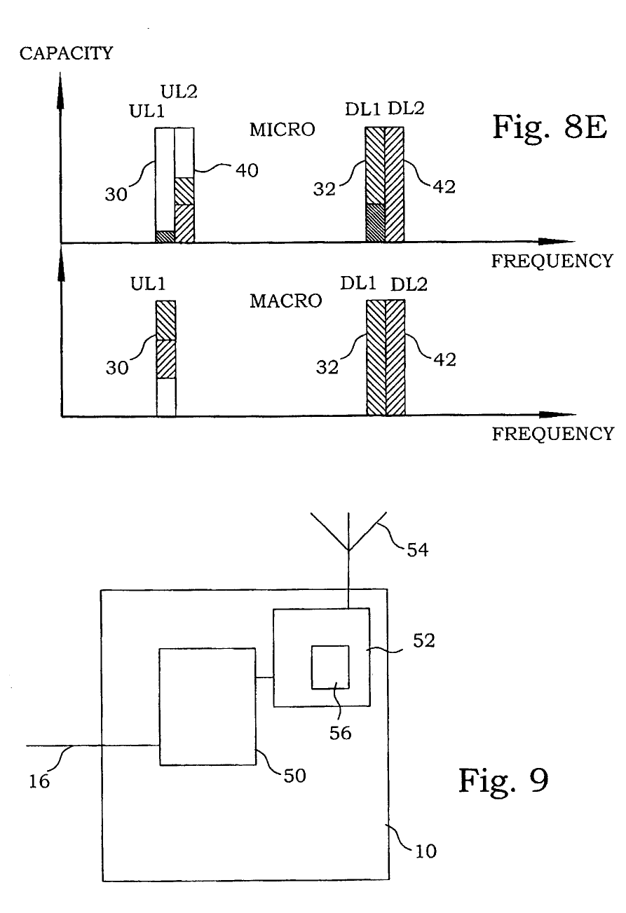

First, as a comparison, consider the capacities of a prior-art system, as illustrated in FIG. 8A. The capacity of a micro cell is illustrated in the upper part of FIG. 8A, while the capacity of a macro cell is illustrated in the lower part. Two uplink/downlink pairs are available UL1, UL2, DL1, DL2. Assume that there are three micro cell systems within the same macro cell (as in FIG. 6). Each system contributes with interference from the top floor cells being in line-of-sight with the macro cell site. Assume further that there is an uplink/downlink asymmetry, so that there is more downlink traffic than uplink, here in the relation 3 to 1. Also assume a high indoor traffic situation, where the limitations normally arise. In the micro cell, DL1/UL1 is allowed to be used. DL1 32 is thereby fully utilized and UL1 30 is partly utilized. In the macro system, both pairs could be used, but only with the constraint of a fixed duplex distance. DL2 42 can thereby be fully utilized which implies that UL2 40 is partly utilized. Furthermore, since there is no interference between the downlink traffic on DL1 32 in the micro cell and the DL1 32 traffic in the macro cell, all parts of DL1 32 is in principle free to use. However, here the interference between UL1 30 of the micro and macro cells puts a limitation. Since about 1/3 of UL1 30 is occupied by indoor traffic in each indoor system, no remaining capacity of UL1 is available for the macro cell. In this view, UL1 30 can not be used in the macro cell at all. In this scenario, when the indoor capacity is fully used, the outdoor capacity is reduced by 50%.

According to an embodiment of the present invention, the situation illustrated in FIG. 8B can be achieved. The macro cell is here free to use the three carrier pairs of DL1/UL1, DL2/UL2 and DL1/UL2. The situation in the micro cell is unchanged, as illustrated by the top portion of the diagram. In the macro cell, the same traffic as in the prior art case is handled, using the same traditional carrier pairs. However, since use of the carrier pair DL1/UL2, having a different duplex distance, now is possible, also the DL1 capacity in the macro cell can now be utilized. For this traffic, free capacity in the UL2 carrier is used as the uplink. The maximum capacity of both downlink carriers can be utilized in the macro cell, regardless of the capacity requests in the micro cells (if the assumed uplink/downlink asymmetry is unchanged).

According to another embodiment of the present invention, the situation illustrated in FIG. 8C can be achieved. The micro cell is here free to use any of the carrier pairs DL1/UL1 and DL2/UL1. Similarly, the macro cell is free to use the carrier pairs DL1/UL2 and DL2/UL2. Since the downlink traffic do not interfere with each other, each cell can freely utilize the total capacity of both downlink carriers, until the capacity of the respective uplink carrier is utilized. With the assumed uplink/downlink asymmetry, the macro cell capacity will be doubled in comparison with the prior-art case, and so is the micro cell capacity.

It is easy to understand that a system allowing all possible combinations of uplink and downlink carriers will open up for an even more flexible utilization of the total capacity in the system.

The use of an unpaired spectrum, presented in an earlier example, is also efficient in enhancing the capacity in an indoor/outdoor system. According to yet another embodiment of the present invention, the situation illustrated in FIG. 8D can then be achieved. The additional unpaired spectrum is used for uplink traffic in the micro cell. The micro cell is thus free to use any of the carrier pairs DL1/UP and DL2/UP, i.e. two pairs with different duplex distance. The macro cell is here designed according to prior art concepts, allowing the use of the carrier pairs DL1/UL1 and DL2/UL2, having identical duplex distances. Since there only exists interference between uplink carriers between micro and macro cells, all interference is removed by separating the used uplink carrier of the micro cell from the uplink carriers of the macro cell. The macro cell can be fully utilized, i.e. the entire downlink capacity of the both downlink carriers. The micro cell is limited by having access only to one uplink carrier, but with the assumed asymmetry in uplink/downlink traffic, one single uplink carrier is enough to serve two downlink carriers. Compared to the prior-art situation, the indoor cell capacity increases with 100% and so does the outdoor cell capacity, by utilizing an additional carrier of only 25% of the original total bandwidth.

Another embodiment may of course allow a total flexibility in pairing the uplink and downlink carriers.

According to yet another embodiment of the present invention, the situation illustrated in FIG. 8E can be achieved. Such an embodiment is suitable for migration between a system according to prior art and a system according to the present invention. The micro cell is allowed to utilize all possible combinations of available uplink and downlink carriers. The entire capacity in the downlink direction can then be used in the micro cell. In a first stage, where only a few mobile units are provided with flexible duplex distance facilities, most mobile units are forced to use the traditional pairs of uplink/downlink carriers. However, in order not to reduce the available uplink carrier capacity for the macro cell, at least one of the uplink carriers in the micro cell should be provided with admission control facilities. In the present embodiment, UL1 is assumed to be equipped with admission control.

When a mobile unit according to prior art is registered at the micro cell, it has to be given an uplink/downlink pair with the normal duplex distance. For low traffic situations, the pair DL2/UL2 can be used. When this carrier pair is fully used, the pair DL1/UL1 can be used if the admission control admits. Mobile units with functionality according to the present invention are more flexible and may e.g. use the pair DL1/UL2, which does not interfere with the macro system.

A mobile according to prior art will use the pair DL1/UL1 at the macro system. When it will make handover to a micro cell, it can either make a hard handover to DL2/UL2 of the micro cell, or make a soft handover to DL1/UL1 of the micro cell whereafter the mobile could be moved within the micro cell from DL1/UL1 to DL2/UL2 in order not to load UL1/DL1 too much.

When the relative amount of mobile units according to the present invention increases, the admission control may eventually be omitted, since the probability that “old” mobiles occupy more than the entire DL2/UL2 pair becomes negligible.

As a summary of the indoor/outdoor example one may notice the following. There is a large potential for WCDMA DAS. The indoor DAS system hardly suffers at all from the macro cell using the same carrier, nor from visiting mobile stations connected to macro cells operating on adjacent carriers. The same DAS carrier may be reused on each floor and in each building. The capacity on each floor will be close to the capacity of an isolated cell. Deploying indoor DAS using the same carrier as in the macro-cell always off-loads the macro cell, provided that the DAS has public access. The macro-cell system hardly suffers at all from increased DAS traffic (beyond what was originally off-loaded) on non-line-of-sight floors. However, the macro cell system suffers from increased DAS traffic (beyond what was originally off-loaded) on line-of-sight floors. This leads to the conclusion that the same only one carrier preferably shall be used within the whole macro cell structure for DAS. If heavily utilized, in particular on upper floors, the macro cell capacity on the DAS carrier will become very low due to uplink interference from DASs, although the total traffic within the macro cell area will be manifold larger than the original macro cell traffic on this carrier.

Operators should have at least 2 FDD carriers deployed for the macro cell infrastructure. This is mainly because he will need all available capacity for macro cell services, but also to have access in buildings with DAS in which he is not a taking part. This is in turn because a visiting WCDMA mobile station, which cannot make handover to the DAS, operating on a carrier adjacent to a DAS WCDMA carrier will often suffer from interference. This interference will be substantially lowered if handover can be made to a second macro cell carrier with 10 MHz carrier separation for the DAS carrier. A safe procedure is to start WCDMA outdoor macro cell deployment utilizing all carriers everywhere, and using only one of these carriers everywhere also as DAS carrier, as the need for DASs develops.

According to the present invention, by removing the traditional fixed association and/or fixed carrier frequency spacing between FDD uplinks and downlinks, the spectrum utilization, in particular for a combined indoor DASs and macro cell scenario, could be much improved. In fact, all indoor DAS traffic could be added on the licensed macro cell spectrum without any reduction of the macro cell capacity. According to the invention, the macro cell system and the indoor systems of a wide band CDMA FDD (WCDMA) system operator may use the same down link carriers, but the macro cell system capacity shall be made more or less independent of available uplink carrier capacity on the uplink carrier used by the indoor system.

Some basic steps of a method according to an embodiment of the present invention are illustrated in FIG. 1l. The procedure starts in step 200. In step 202, a first carrier pair is selected by associating one uplink and one downlink carrier. The frequency difference between the uplink and downlink carriers is F1. In step 204, a second carrier pair is selected by associating one uplink and one downlink carrier. The frequency difference between the uplink and downlink carriers in this second pair is F2. F2 is a frequency difference different from F1. The procedure is ended in step 206. The steps 202 and 204 are performed within the same cellular communication system. They may be performed within the same cell or in different cells of the cellular system. Preferably the association is made on a per connection or per code basis.

Moreover, specific procedures for handover between FDD cells with differing duplex frequency distances have to be provided. For this purpose, downlink broadcast/control information, neighbor cell lists and/or handover messages shall contain information on duplex distances. The required new handover procedure could in principle utilize soft handover in the downlink and hard handover in the uplink, when making handover between carriers with different duplex frequency separation distances. A good property in layered systems as discussed further above is that the downlink can be the same in both layers. This means that the normal non-compressed handover mode could be followed by hard handover (of both links), or by hard handover for the uplink and some kind of soft handover for the downlink. This downlink soft handover may be complex to realize. The uplink will make a hard handover, and therefore the power control loop will also experience hard switching. There may be some possibilities to keep power control for both down links, for instance to send power control information for both downlinks on the single active uplink combined with power information transfer between the RBSs. A more practical approach could be to just let the old downlink remain at the last power setting during a hangover time of a few seconds, after the mobile has switched to the new uplink. No matter which kind of handover that is implemented, when a mobile detects a neighbor cell to which the mobile should make handover, it must get information on the duplex separation distance to the new uplink. This information can be contained in the adjacent cell list, or be provided by a message in conjunction with the actual handover commands from the system side.

Handover issues according to prior art, in particular soft handover and hard handover, and layered infrastructures for WCDMA are discussed in e.g. 3GPP TSG RAN 25 331 “RRC Protocol Specification (Release 1999)”, September 2001, and in “Microcell Engineering in CDMA Cellular Networks”, IEEE Transactions on Vehicular Technology, Vol. 43, No. 4, November 1994, pp. 817-825, which are hereby incorporated by reference in their entirety.

Mobiles have to be provided with means that allows operation on, and to make handover between, carriers with different duplex frequency separation.

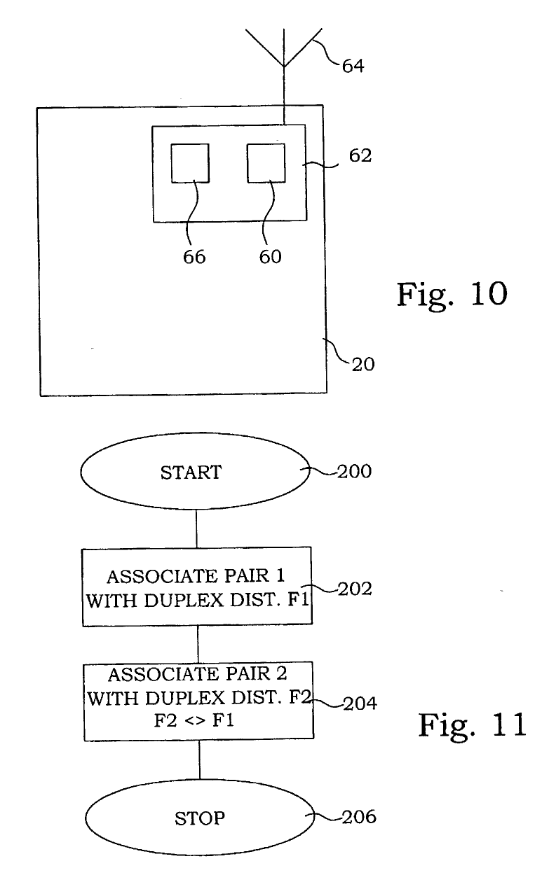

Design of a mobile with handover between carriers with different duplex frequency separation distances would typically require two local oscillators or VCO's. FIG. 10 illustrates a mobile station 20 comprising an antenna 64 for communication via radio frequency waves with a base station. A transceiver unit 62 controls the sending and receiving of radio signals. Upon entering an active mode, the mobile station 20 is informed about which carrier pair that is going to be used. A duplex distance unit 60 in the transceiver unit 62 receives this information, preferably stores it and instructs the transceiver unit 62 to use the specific uplink and downlink carriers defined.

The transceiver unit 62 further comprises means 66 for performing handover between carrier pairs of differing duplex frequency separation.

Base stations have similarly to be equipped with variable association and/or different RF-carrier frequency separation between uplink and downlink carrier pairs. It is important that all control functions, e.g. the fast power control functions, do not suffer when the carrier association are flexible. Furthermore the BRS downlink broadcast/control information has to contain direct or indirect information on duplex distances, so that the mobile knows on which uplink carrier to send an access request. FIG. 9 illustrates a base station 10 comprising an antenna 54 for communication via radio frequency waves with mobile stations. A transceiver unit 52 controls the sending and receiving of radio signals. When a mobile is registered or when a mobile comes into active mode, a carrier pair for communication has to be identified, on which the subsequent communication is intended to take place. A carrier utilization unit 50 in the base station 10 provides a suitable uplink/downlink pair and provides the transceiver unit 62 with information about both the frequencies, or alternatively one of the frequencies and the actual frequency separation. This information is forwarded to the mobile in question. Preferably, the carrier utilization unit 50 is connected to the core network, to exchange information about which carriers that are in use, the present traffic situation etc. The carrier utilization unit 50 may comprise storage of pre-determined carrier -pairs, which are retrieved when needed. Alternatively or complementary, the carrier utilization unit 50 may compute advantageous carrier pairs intermittently or continuously.

The transceiver unit 52 further comprises means 56 for providing handover between carrier pairs of differing duplex frequency separation.

In FIG. 9, the carrier utilization unit 50 is provided in the base station 10. It is, however, also possible to locate the carrier utilization unit 50 in any other node of the cellular communication system, or to let the carrier utilization unit 50 have a distributed design, with part units in different levels of the core network. In systems, where a large flexibility is used, a more centralized location of the carrier utilization unit 50 is to be preferred.

Communication protocols between base stations and mobile stations have to comprise information indicating the actual frequencies of both carriers, or alternatively, one of the frequencies and the used duplex distance. Such a modification of already existing protocols is believed to be easily implemented. In WCDMA in Europe of today, a broadcast message on each downlink with RACH information (#5) comprises system information. Today, this message contains no explicit UL carrier information. A hard coupled 190 MHz duplex distance is used to lock the mobile to the right uplink frequency. However, to work in the US, where the downlink band is the same, but the uplink band is different, the WCDMA standard will be changed to add a new broadcast message (#5bis), which adds RACH uplink carrier frequency information. A mobile may by this recognize that it is present in a system with a constant but different duplex distance, when first registering to the system.

Such a message could be used for indication of the actual required duplex distance in the present invention. By using such a message for each occasion where a carrier pair is going to be assigned, the principles of the present invention can be used. Also for other types of systems, only minor modifications of already existing communication protocols will provide the necessary information between the base station and the mobile unit.

The principles of the invention can also be applied to e.g. systems like GSM. In this case the de-coupling of the fixed uplink and downlink association would be utilized for optimized de-coupled reuse patterns for uplinks and downlinks.

There are also nice migration scenarios for successively incorporate the present invention into systems of today. Base stations operating according to prior art can still be utilized together with base stations operating according to the present invention. The system-wide association scheme of carrier pairs has to be adapted accordingly. Moreover, as long as a substantial part of mobile stations utilizing the system, the operator has to ensure that each cell still has the possibility to use carrier pairs according to prior art constant duplex distance. An exception of this may be done for overlay/underlay systems, where the underlay systems may operate entirely according to the new concepts, and where mobile stations not supporting the flexible duplex distance are referred to use solely the macro cell. This may be interesting when a sufficiently large portion of the mobile stations support flexible duplex distance communication. The relatively high compatibility between the prior art systems and systems operating entirely according to the new principles makes it easy to migrate between the two concepts in a step-by-step manner.

The invention substantially increases the spectrum utilization for cellular deployments in general. It is particularly advantageous if combined with public macro cell and indoor deployments. It is especially useful for, but not limited to, the spectrum allocations for WCDMA, where an operator with a typical European spectrum allocation could double the available macro cell capacity when combined with high capacity indoor underlay infrastructures.

It will be understood by those skilled in the art that various modifications and changes may be made to the present invention without departure from the scope thereof, which is defined by the appended claims.

1. Cellular communication system utilizing a number of uplink carriers and a number of downlink carriers, comprising:
base stations for communication with mobile units;
core network connecting said base stations;
said base stations utilizing carrier pairs of one of said uplink carriers and one of said downlink carriers for communication with said mobile units;
at least a first of said carrier pairs having a different duplex frequency separation than a second of said carrier pairs.

2. Cellular communication system according to claim 1, wherein a first base station utilizes said first carrier pair and a second base station utilizes said second carrier pair.

3. Cellular communication system according to claim 2, wherein said first base station is a base station for a macro cell and said second base station is a base station for a micro cell situation within said macro cell.

4. Cellular communication system according to claim 3, wherein said first base station utilizes at least one uplink carrier not utilized by said second base station.

5. Cellular communication system according to claim 1, wherein a base station utilizes said first carrier pair for communication with a first mobile unit and said second carrier pair for communication with a second mobile unit.

6. Cellular communication system according to claim 1, wherein at least one of said uplink carriers is an unpaired carrier.

7. Cellular communication system according to claim 1, wherein at least one of said downlink carriers is an unpaired carrier.

8. Cellular communication system according to claim 1, further comprising means for including information on a duplex frequency separation on a downlink broadcast channel.

9. Cellular communication system according to claim 1, further comprising a neighbor cell list comprising information on an associated duplex frequency separation.

10. Node of a cellular communication system having access to a number of uplink carriers and a number of downlink carriers, comprising:
transceiver means for communication with mobile units;
said transceiver means utilizing carrier pairs of one of said uplink carriers and one of said downlink carriers for communication with said mobile units;
at least a first of said carrier pairs having a different duplex frequency separation than a second of said carrier pairs.

11. Node according to claim 10, further comprising means for selecting said carrier pairs for improving carrier utilization in said cellular communication system.

12. Node according to claim 11, wherein said means for selecting said carrier pairs operates on a per connection and/or per code basis.

13. Node according to claim 10, further comprising means for performing handover between carrier pairs of differing duplex frequency separation.

14. Node according to claim 10, further comprising means for including information on a duplex frequency separation on a downlink broadcast channel.

15. Node according to claim 10, further comprising a neighbor cell list comprising information on an associated duplex frequency separation.

16. Mobile unit for use in a cellular communication system having access to a number of uplink carriers and a number of downlink carriers, comprising:
transceiver means for communication with a base station;
said transceiver means utilizing carrier pairs of one of said uplink carriers and one of said downlink carriers for communication with said mobile units;
said transceiver means being capable of using carrier pairs with different duplex frequency separation; and
means for performing handover between carrier pairs of differing duplex frequency separation.

17. Mobile unit according to claim 16, further comprising means for extracting information on a duplex frequency separation from a downlink broadcast channel signal.

18. Mobile unit according to claim 16, further comprising means for extracting information on an associated duplex frequency separation from a neighbor cell list.

19. Method of providing carriers in a cellular communication system, comprising the steps of:
associating one of a number of uplink carriers with one of a number of downlink carriers in carrier pairs;
at least a first of said carrier pairs having a different duplex frequency separation than a second of said carrier pairs.

20. Method according to claim 19, comprising the further steps of:
providing traffic information data;
whereby said associating step is adapted in response to said traffic information data.

21. Method according to claim 19, wherein said associating step is performed on a per connection or code basis.

22. Method according to claim 19, wherein at least one of said downlink carriers is an unpaired carrier.

23. Method according to claim 19, wherein at least one of said uplink carriers is an unpaired carrier.

24. Method according to claim 19, further comprising the step of:
using said first and second carrier pairs in one and the same cell of said cellular communication system.

25. Method according to claim 19, further comprising the step of:
using said first and second carrier pairs in different cells of said cellular communication system.

26. Method according to claim 25, wherein said first carrier pair is used in a macro cell and said carrier pair is used in a micro cell within said macro cell.

27. Method according to claim 26, wherein said macro cell uses at least one uplink carrier not utilized by said micro cell.

28. Method according to claim 19, comprising the further step of providing information on a duplex frequency separation on a downlink broadcast channel.

29. Method according to claim 19, comprising the further step of providing information on an associated duplex frequency separation on a neighbor cell list.
